(19) United States
(12) Patent Application Publication
(10) Pub. No.: US 2014/0070138 A1
(43) Pub. Date: Mar. 13, 2014

(54) HYDROGEN STORAGE COMPOSITE MATERIALS AND METHODS OF FORMING THE SAME

(71) Applicant: INDUSTRIAL TECHNOLOGY RESEARCH INSTITUTE, Chutung (TW)

(72) Inventors: Chun-Ju HUANG, Zhubei City (TW); Chia-Hung KUO, Tainan City (TW); Chien-Yun HUANG, Zhudong Township (TW)

(73) Assignee: INDUSTRIAL TECHNOLOGY RESEARCH INSTITUTE, Chutung (TW)

(21) Appl. No.: 13/957,081

(22) Filed: Aug. 1, 2013

(30) Foreign Application Priority Data
Sep. 12, 2012 (TW) 101133245

(51) Int. Cl. C01B 3/00

(52) U.S. Cl. CPC C01B 3/0078
USPC 252/183.14

(57) ABSTRACT

A hydrogen storage composite and a method of forming the same are provided. The hydrogen storage composite includes a catalyst mixed with a hydrogen storage base material and a transition metal for catalyzing hydrogen desorption embedded on the surfaces of the hydrogen storage base material and the catalyst. The method includes providing at least one active metal and performing a lengthy time ball mill process to form a catalyst, providing a hydrogen storage base material to mix with the catalyst and performing a lengthy time ball mill process to form a hydrogen storage alloy material, and providing a transition metal for catalyzing hydrogen desorption to mix with the hydrogen storage alloy material and performing a shortened time ball mill process to form a hydrogen storage composite.

### CROSS REFERENCE TO RELATED APPLICATIONS

This Application claims priority of Taiwan Patent Application No. 101133245, filed on Sep. 12, 2012, the entirety of which is incorporated by reference herein.

### BACKGROUND

1. Technical Field

The technical field relates to a hydrogen storage material and a method of forming the same.

2. Description of the Related Art

The key point for hydrogen energy economy is low-cost, safe and stable storage and transportation of hydrogen The storages of hydrogen gas in high pressure tanks has disadvantages such as low volumetric capacities and safety problems for applications. As such, metal or alloy for hydrogen storage is the most promising way. Metals and alloys form metal hydrides with hydrogen leading to solid-state storage under moderate temperature and pressure that gives them the important safety advantage over the compressed gas and liquid storage methods.

The alloy with a high hydrogen storage amount such as Mg-based alloys is not practicable due to poor kinetics of adsorption/desorption and high dehydriding temperature (e.g. usually higher than 300° C.). Accordingly, a composite material which can rapidly adsorb and release hydrogen gas at a lower temperature to be applied in stable storage is called-for.

### SUMMARY

According to embodiments, hydrogen storage composite materials combine a hydrogen storage alloy material with a transition metal that can catalyze hydrogen desorption and fabrication methods thereof are provided. The hydrogen storage composite materials have advantages of a high hydrogen storage amount and a rapid hydrogen absorption rate. Furthermore, the hydrogen storage composite materials can release hydrogen at a low temperature which is advantageous to the operation of hydrogen energy applications.

One embodiment provides a hydrogen storage composite material, comprising: a catalyst mixed with a hydrogen storage base material, wherein the catalyst and the hydrogen storage base material form an alloy phase. A transition metal that can catalyze hydrogen desorption is embedded on surfaces of the hydrogen storage base material and the catalyst, wherein the transition metal and the hydrogen storage base material do not form any alloy phase. A hydrogen storage base material is provided to mix with the catalyst that can promote hydriding reaction and then a second step ball milling process is performed to form a hydrogen storage alloy material, wherein the second step ball milling process is performed by a time of 6 hours to 12 hours.

One embodiment provides a method of forming a hydrogen storage composite material, comprising: providing at least one kind of active metal and performing a first step ball milling process to form a catalyst that can promote hydrogen absorption, wherein the first step ball milling process is performed by a time of 6 hours to 12 hours. A hydrogen storage base material is provided to mix with the catalyst and a second step ball milling process is performed to form a hydrogen storage alloy material, wherein the second step ball milling process is performed by a time of 6 hours to 12 hours. A transition metal that can promote dehydriding is provided to mix with the hydrogen storage alloy material and a third step ball milling process is performed to form a hydrogen storage composite material, wherein the third step ball milling process is performed by a time of 30 minutes to one hour.

A detailed description is given in the following embodiments with reference to the accompanying drawings.

### BRIEF DESCRIPTION OF THE DRAWINGS

The disclosure can be more fully understood by reading the subsequent detailed description and examples with reference to the accompanying drawings, wherein:

FIG. 1 shows a partial plane view of a hydrogen storage composite material according to an embodiment;

FIG. 2 shows a flow chart of a method of forming a hydrogen storage composite material according to an embodiment;

FIG. 3 shows curves of the hydrogen absorption/desorption amounts versus times of Example 1 and Comparative Example 1;

FIG. 4 shows curves of the hydrogen absorption/desorption amounts versus times of Example 1 and Comparative Example 2; and

FIG. 5 shows curves of the hydrogen absorption/desorption amounts versus times of Example 2 and Example 3.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein.

The embodiments use a hydrogen storage base material, having a high hydrogen storage amount, combined with a catalyst, for enhancing hydrogen absorption efficiency of the hydrogen storage base material, to form a hydrogen storage alloy material. Furthermore, a transition metal that can catalyze hydrogen desorption for enhancing dehydriding efficiency of the hydrogen storage base material is provided, which is embedded on the surface of the hydrogen storage alloy material to form a hydrogen storage composite material of the transition metal and the hydrogen storage alloy material. The hydrogen storage composite material had advantages of a high hydrogen storage amount, a rapid hydrogen absorption rate and a low dehydriding temperature.

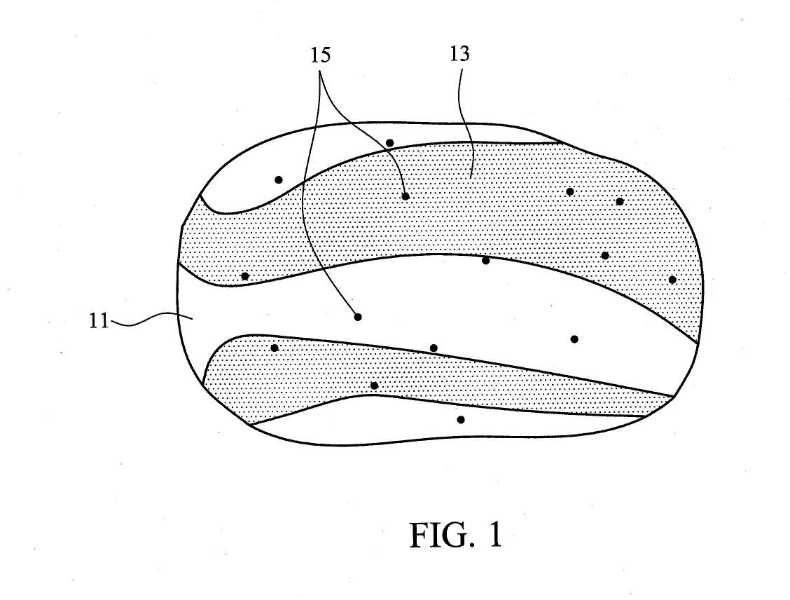

Referring to FIG. 1, a partial plane view of a hydrogen storage composite material according to an embodiment is shown. The hydrogen storage composite material includes a hydrogen storage base material 11 mixed with a catalyst 13 to form a hydrogen storage alloy material. Furthermore, a transition metal 15 is embedded on the surfaces of the hydrogen storage base material 11 and the catalyst 13.

The hydrogen storage base material 11 is a material having a high hydrogen storage amount, for example magnesium or magnesium hydride. The catalyst 13 is formed from at least one kind of active metal or combinations of several kinds of active metals. The active metals include an active metal for catalyzing hydrogen molecule dissociation, such as Pt, Pd, Ti, etc. and another active metal for reducing the hydrogen atom penetrating energy barrier, such as Fe, Mn, V, etc. The transition metal 15 that can promote dehydriding is a nanometer sized metal having a low affinity for hydrogen. When the transition metal 15 and hydrogen atom form a hydride, the hydrogenation process is an endothermic reaction (ΔH>0). The transition metal 15 is for example Ni or Al or an alloy thereof. The size of the transition metal 15 may be 10-100 nm. The transition metal 15 may be one kind of metal that can promote dehydriding or an alloy of two kinds or more than two kinds of metals that can promote dehydriding. The transition metal 15 had a function of reducing the hydrogen desorption energy barrier of the hydrogen storage base material.

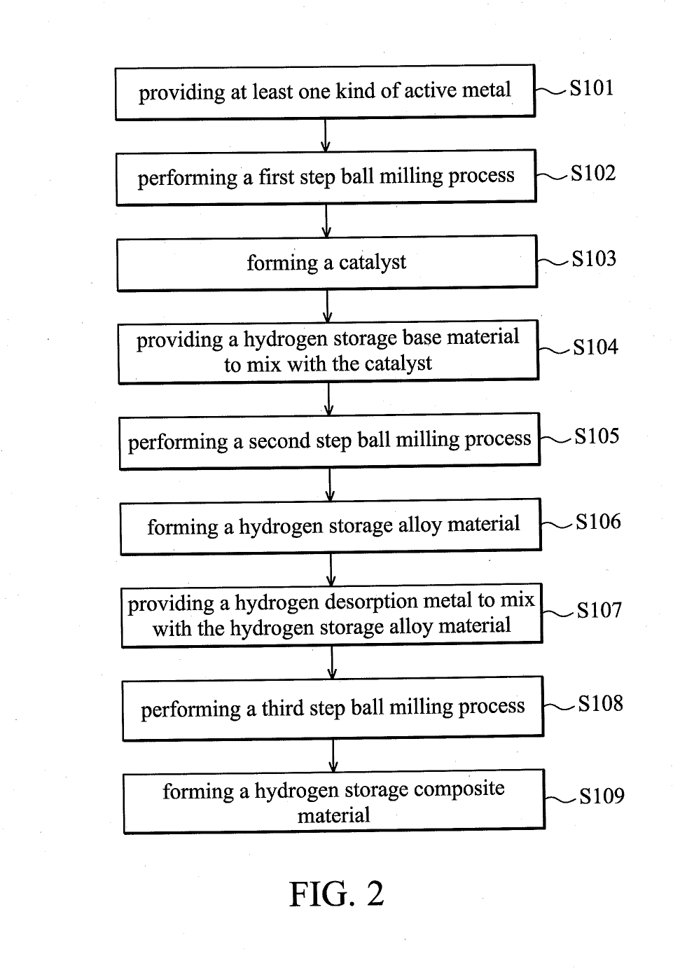

Referring to FIG. 2, a flow chart of a method of forming a hydrogen storage composite material according to an embodiment is shown. Firstly, at a step S101, at least one kind of active metal is provided. The active metal includes an active metal for catalyzing hydrogen molecule dissociation, for example Pt, Pd or Ti, another active metal for reducing the hydrogen atom penetrating energy barrier, for example Fe, Mn or V, or combinations thereof. At a step S102, a first step ball milling process is performed. At the step S102, the at least one kind of active metal is grinded by a high energy ball milling process with a lengthy time of about 6 hours to 12 hours. During the first step ball milling process, a plurality of carbon nanotubes is added as a grinding aid. The additional amount of the carbon nanotubes may be 1-5 wt % based on a total weight of the active metal. The first step ball milling process can be performed under an inert gas, such as argon or nitrogen gas environment. At a step S103, after the first step ball milling process, a nanometer sized or a submicrometer sized catalyst powder is formed. If several kinds of active metals are provided at the first step ball milling process, an alloy-typed catalyst powder would be formed, for example a FeTi alloy powder. The catalyst powder had a size of about 10 nm-100 nm.

At a step S104, a hydrogen storage base material, for example magnesium, is provided to mix with the catalyst formed by the above mentioned step, for example a FeTi alloy powder. A weight ratio of the catalyst mixed with the hydrogen storage base material is about 3:7 to 1:9. At a step S105, a second step ball milling process is performed. The hydrogen storage base material and the catalyst are grinded by a high energy ball milling process with a lengthy time of about 6 hours to 12 hours. During the second step ball milling process, a plurality of carbon nanotubes is added as a grinding aid. The additional amount of the carbon nanotubes may be 1-5 wt % based on a total weight of the hydrogen storage base material and the catalyst. The second step ball milling process can be performed under an inert gas, such as an argon or nitrogen gas environment. At a step S106, after a lengthy time of grinding of the second step ball milling process, the hydrogen storage base material and the catalyst form an alloy phase and a grain size of the hydrogen storage base material and the catalyst is reduced to form a hydrogen storage alloy material powder having a high hydrogen absorption efficiency. The hydrogen storage alloy material powder had a size of about 10 nm-100 nm.

At a step S107, a transition metal that can catalyze hydrogen desorption, for example Ni, is provided to mix with the hydrogen storage alloy material formed by the above mentioned step. A weight ratio of the hydrogen storage alloy material mixed to the hydrogen desorption metal is about 98:2 to 90:10. At a step S108, a third step ball milling process is performed. The hydrogen storage alloy material and the transition metal are grinded by a high energy ball milling process with a shortened time of about 30 minutes to about one hour. During the third step ball milling process, no carbon nanotube is added. The third step ball milling process can be performed under an inert gas, such as an argon or nitrogen gas environment.

At a step S109, after the shortened time of grinding of the third step ball milling process, the transition metal is embedded on the surface of the hydrogen storage alloy material, i.e. the transition is embedded on the surfaces of the hydrogen storage base material and the catalyst to form a nanometer sized composite material of the transition metal and the hydrogen storage alloy. The nanometer sized composite material is a hydrogen storage composite material of the embodiments, wherein the transition metal is 2-10% by weight based on a weight of the hydrogen storage composite material. Because the third step ball milling process is performed by a shortened time, the transition metal and the hydrogen storage base material do not form an alloy phase. The transition metal is embedded on the surface of the hydrogen storage alloy material. Thus, the catalysis function of the transition metal directly acts on the surface of the hydrogen storage alloy material to further improve the dehydriding efficiency and reduce the dehydriding energy barrier of the hydrogen storage alloy material. Therefore, the hydrogen storage composite materials of the embodiments have an excellent hydrogen desorption amount of greater than 3.5 wt % at a low temperature of about 140° C. -180° C. and an effect of reducing the dehydriding temperature is achieved.

### EXAMPLE 1

### Addition of Nanometer Sized Ni Metal

Two kinds of metals, Fe and Ti were mixed together having a mole ratio of 1:1, and 1 wt % of carbon nanotubes (based on a total weight of Fe and Ti) were added to the two kinds of metals, wherein a high energy ball milling process for 12 hours under an argon gas environment at a normal pressure and a room temperature was performed to the two kinds of metals to form the nanometer sized FeTi alloy powder.

Then, the FeTi alloy powder was mixed with a magnesium metal by a weight ratio of 3:7, and 1 wt % of carbon nanotubes (based on a total weight of the FeTi alloy powder and the magnesium metal) were added to the FeTi alloy powder and the magnesium metal, wherein a high energy ball milling process for 12 hours under an argon gas environment at a normal pressure and a room temperature was performed to the FeTi alloy powder and the magnesium metal to form the nanometer sized hydrogen storage alloy powder.

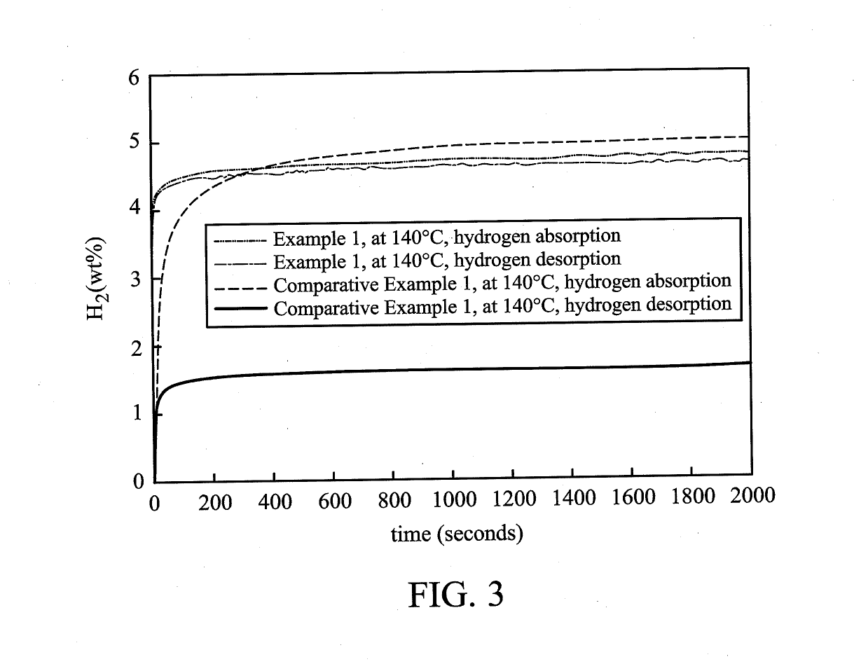

The hydrogen storage alloy powder was mixed with a nanometer sized (<100 nm) Ni metal by a weight ratio of 92:8, wherein a high energy ball milling process with 30 minutes under an argon gas environment at a normal pressure and a room temperature to form a hydrogen storage composite material of Example 1. The hydrogen storage composite material of Example 1 had the nanometer sized Ni embedded on the surfaces of the magnesium base material and the FeTi alloy. The curves of the hydrogen absorption/desorption amounts versus times of the hydrogen storage composite material of Example 1 at 140° C. is shown in FIG. 3.

### Comparative Example 1

### No Addition of Nanometer Sized Ni Metal

Two kinds of metals, Fe and Ti were mixed together having a mole ratio of 1:1, and 1 wt % of carbon nanotubes (based on a total weight of Fe and Ti) were added to the two kinds of metals, wherein a high energy ball milling process for 12 hours under an argon gas environment at a normal pressure and a room temperature was performed to the two kinds of metals to form the nanometer sized FeTi alloy powder.

Then, the FeTi alloy powder was mixed with a magnesium metal by a weight ratio of 3:7, and 1 wt % of carbon nanotubes (based on a total weight of the FeTi alloy powder and the magnesium metal) were added to the FeTi alloy powder and the magnesium metal, wherein a high energy ball milling process for 12 hours under an argon gas environment at a normal pressure and a room temperature was performed to the FeTi alloy powder and the magnesium metal to form the nanometer sized hydrogen storage alloy powder of Comparative Example 1. The curves of the hydrogen absorption/desorption amounts versus times of the nanometer sized hydrogen storage alloy powder of Comparative Example 1 at 140° C. is shown in FIG. 3.

### Comparative Example 2

### Addition of Nanometer Sized Ni Metal and Performing a Lengthy Time of Grinding

Two kinds of metals, Fe and Ti were mixed together having a mole ratio of 1:1, and 1 wt % of carbon nanotubes (based on a total weight of Fe and Ti) were added to the two kinds of metals, wherein a high energy ball milling process for 12 hours under an argon gas environment at a normal pressure and a room temperature was performed to the two kinds of metals to form the nanometer sized FeTi alloy powder.

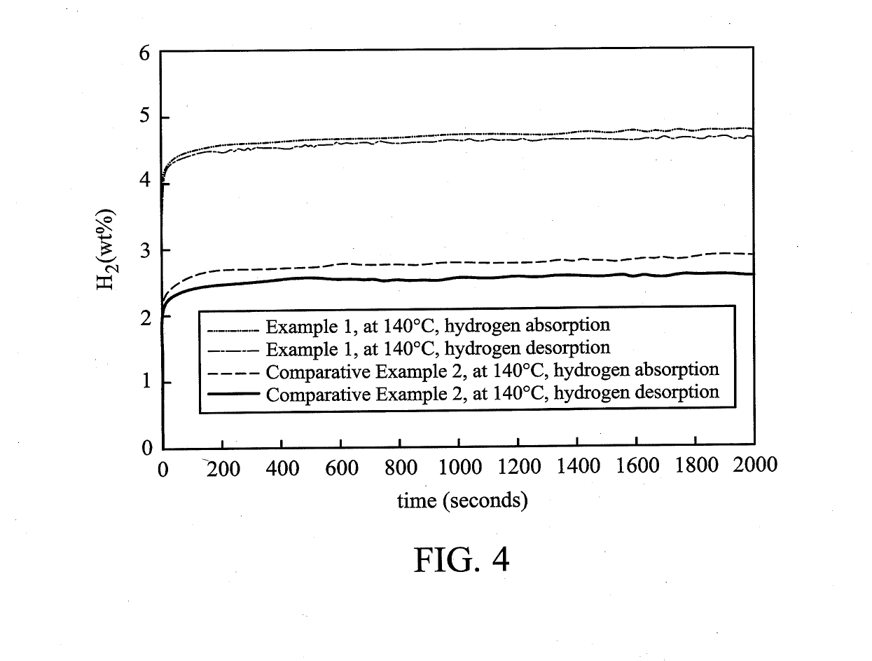

Then, 8 wt % of a nanometer sized (<50 nm) Ni metal (based on a total weight of the FeTi alloy powder, the magnesium metal and the nanometer sized Ni metal) was mixed with the magnesium metal, the magnesium metal were added to the FeTi alloy powder, the magnesium metal and the nanometer sized Ni metal, wherein a high energy ball milling process for 12 hours under an argon gas environment at a normal pressure and a room temperature was performed to the FeTi alloy powder and the magnesium metal to form the nanometer sized hydrogen storage alloy powder of Comparative Example 2. The curves of the hydrogen absorption/desorption amounts versus times of the nanometer sized hydrogen storage alloy powder of Comparative Example 2 at 140° C. is shown in FIG. 4.

The test for the hydrogen absorption/desorption amounts of the hydrogen storage materials of Example 1 and Comparative Examples 1-2 was performed by a volume method, in which a pressure-composition-temperature (PCT) test apparatus was used to measure the hydrogen absorption/desorption amounts. The method for the calculation of the hydrogen desorption amount was the PCT negative pressure hydrogen desorption method.

Comparing the curves of the hydrogen absorption/desorption amounts versus times of the hydrogen storage composite material of Example 1 and the hydrogen storage alloy powder of Comparative Example 1 at 140° C. as shown in FIG. 3, the hydrogen storage composite material of Example 1 with the addition of the nanometer sized Ni metal had a hydrogen desorption amount of 4.71 wt % at 140° C. However, the hydrogen storage alloy powder of Comparative Example 1 without the addition of the nanometer sized Ni metal had a hydrogen desorption amount of 1.7 wt % at 140° C. As a result, it was shown that the hydrogen storage composite materials of the embodiments with the addition of the nanometer sized Ni metal can significantly improve the dehydriding efficiency of hydrogen storage materials. Furthermore, the hydrogen desorption temperature of the hydrogen storage material was also reduced. Therefore, the hydrogen storage composite materials of the embodiments can decrease the consumption of energy when the hydrogen storage composite materials are applied to hydrogen energy storage.

Comparing the curves of the hydrogen absorption/desorption amounts versus times of the hydrogen storage composite material of Example 1 and the nanometer sized hydrogen storage alloy powder of Comparative Example 2 at 140° C. as shown in FIG. 4, the hydrogen storage composite material of Example 1 with the addition of the nanometer sized Ni metal and performed at a shortened ball milling process time (30 minutes) had hydrogen absorption/desorption amounts at 140° C., which was significantly greater than that of the hydrogen storage alloy powder of Comparative Example 2 with the addition of the nanometer sized Ni metal performed with a lengthy ball milling process time (12 hours). As a result, if the formation of a hydrogen storage material is performed with the addition of the nanometer sized Ni metal but is not performed with a shortened ball milling process time, the nanometer sized Ni metal and a hydrogen storage base material will form an alloy phase. Although the hydrogen storage material of Comparative Example 2 had a hydrogen desorption amount of 2.6 wt % which was slightly higher than the hydrogen desorption amount of 1.7 wt % of the hydrogen storage material of Comparative Example 1, the hydrogen absorption amount of 2.6 wt % of the hydrogen storage material of Comparative Example 2 was much lower than the hydrogen absorption amount of 5 wt % of the hydrogen storage material of Comparative Example 1.

### EXAMPLE 2

### Increasing the Amount of Carbon Nanotubes

Two kinds of metals, Fe and Ti were mixed together having a mole ratio of 1:1, and 1 wt % of carbon nanotubes (based on a total weight of Fe and Ti) were added to the two kinds of metals, wherein a high energy ball milling process for 12 hours under an argon gas environment at a normal pressure and a room temperature was performed to the two kinds of metals to form the nanometer sized FeTi alloy powder.

Then, the FeTi alloy powder was mixed with a magnesium metal by a weight ratio of 3:7. Next, 3 wt % of carbon nanotubes (based on a total weight of the FeTi alloy powder and the magnesium metal) were added to the FeTi alloy powder and the magnesium metal for Example 2, wherein a high energy ball milling process for 12 hours under an argon gas environment at a normal pressure and a room temperature was performed to the FeTi alloy powder and the magnesium metal to form the nanometer sized hydrogen storage alloy powders.

Then, 8 wt % of a nanometer sized (<50 nm) Ni metal (based on a total weight of nanometer sized hydrogen storage alloy powders and the nanometer sized Ni metal) was mixed with the nanometer sized hydrogen storage alloy powders, wherein a high energy ball milling process for 30 minutes under an argon gas environment at a normal pressure and a room temperature to form a hydrogen storage composite material of Example 2.

### EXAMPLE 3

### Increasing the Amount of Carbon Nanotubes

Two kinds of metals, Fe and Ti were mixed together having a mole ratio of 1:1, and 1 wt % of carbon nanotubes (based on a total weight of Fe and Ti) were added to the two kinds of metals, wherein a high energy ball milling process for 12 hours under an argon gas environment at a normal pressure and a room temperature was performed to the two kinds of metals to form the nanometer sized FeTi alloy powder.

Then, the FeTi alloy powder was mixed with a magnesium metal by a weight ratio of 3:7. Next, 5 wt % of carbon nanotubes (based on a total weight of the FeTi alloy powder and the magnesium metal) were added to the FeTi alloy powder and the magnesium metal for Example 3, wherein a high energy ball milling process for 12 hours under an argon gas environment at a normal pressure and a room temperature was performed to the FeTi alloy powder and the magnesium metal to form the nanometer sized hydrogen storage alloy powders.

Then, 8 wt % of a nanometer sized (<50 nm) Ni metal (based on a total weight of nanometer sized hydrogen storage alloy powders and the nanometer sized Ni metal) was mixed with the nanometer sized hydrogen storage alloy powders, wherein a high energy ball milling process for 30 minutes under an argon gas environment at a normal pressure and a room temperature to form a hydrogen storage composite material of Example 3.

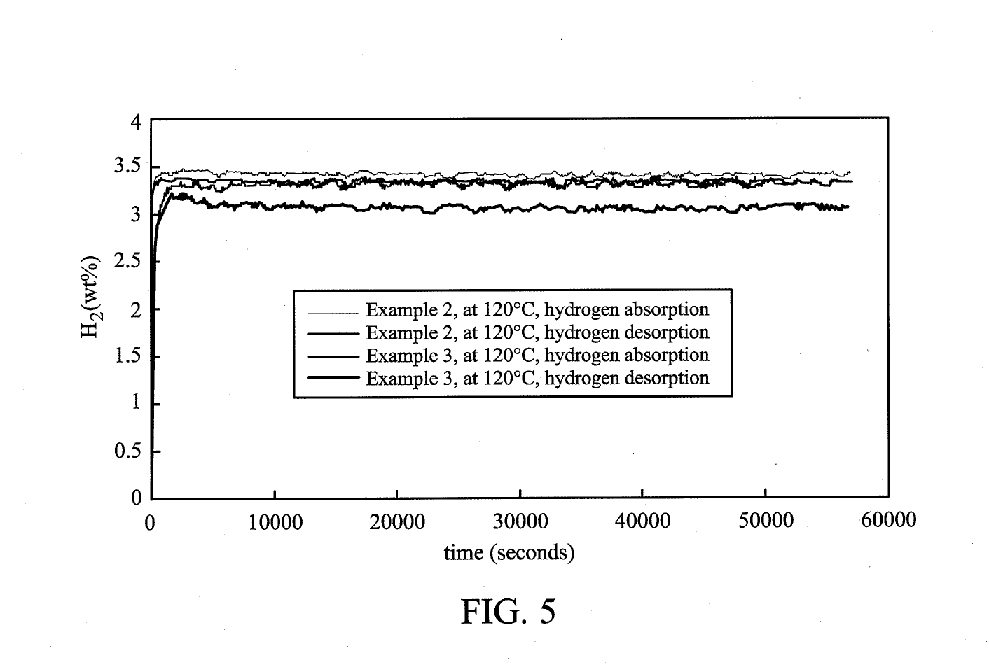

The curves of the hydrogen absorption/desorption amounts versus times of the hydrogen storage composite materials of Example 2 and Example 3 at 120° C. is shown in FIG. 5.

The hydrogen storage composite material of Example 2 had a hydrogen desorption amount of 3.3 wt % at 120° C. and the hydrogen storage composite material of Example 3 had a hydrogen desorption amount of 3.0 wt % at 120° C., which are higher than the hydrogen desorption amounts of Comparative Example 1 (1.7 wt %) and Comparative Example 2 (2.6 wt %) at 140° C.

It will be apparent to those skilled in the art that various modifications and variations can be made to the disclosed embodiments. It is intended that the specification and examples be considered as exemplary only, with a true scope of the disclosure being indicated by the following claims and their equivalents.

what is claimed is:

1. A hydrogen storage composite material, comprising:
a hydrogen storage base material;
a catalyst mixed with the hydrogen storage base material, wherein the catalyst and the hydrogen storage base material form an alloy phase; and
a transition metal for catalyzing hydrogen desorption embedded on surfaces of the hydrogen storage base material and the catalyst, wherein the transition metal and the hydrogen storage base material do not form an alloy phase.

2. The hydrogen storage composite material as claimed in claim 1, wherein the hydrogen storage base material comprises magnesium or magnesium hydride.

3. The hydrogen storage composite material as claimed in claim 1, wherein the catalyst comprises Pt, Pd, Ti, Fe, Mn or V.

4. The hydrogen storage composite material as claimed in claim 1, wherein the catalyst comprises FeTi.

5. The hydrogen storage composite material as claimed in claim 1, wherein the transition metal comprises Ni or Al, and the transition metal had a size of 10-100 nm.

6. The hydrogen storage composite material as claimed in claim 1, wherein the catalyst mixed with the hydrogen storage base material had a weight ratio of 3:7 to 1:9, and the transition metal is 2 to 10 percent by weight based on the weight of the hydrogen storage composite material.

7. A method of forming a hydrogen storage composite material, comprising:
providing at least one kind of active metal and performing a first step ball milling process to form a catalyst, wherein the first step ball milling process is performed by a time of 6 hours to 12 hours;
providing a hydrogen storage base material to mix with the catalyst and performing a second step ball milling process to form a hydrogen storage alloy material, wherein the second step ball milling process is performed by a time of 6 hours to 12 hours; and
providing a transition metal for catalyzing hydrogen desorption to mix with the hydrogen storage alloy material and performing a third step ball milling process to form a hydrogen storage composite material, wherein the third step ball milling process is performed by a time of 30 minutes to one hour.

8. The method as claimed in claim 7, further comprising adding a plurality of carbon nanotubes during the steps of performing the first step ball milling process and the second step ball milling process.

9. The method as claimed in claim 7, wherein the first, the second and the third step ball milling processes are performed under an inert gas environment and the inert gas comprises argon or nitrogen.

10. The method as claimed in claim 7, wherein the first, the second and the third step ball milling processes comprise a high-energy ball milling process.

11. The method as claimed in claim 7, wherein the catalyst comprises Pt, Pd, Ti, Fe, Mn or V.

12. The method as claimed in claim 7, wherein the catalyst comprises FeTi.

13. The method as claimed in claim 7, wherein the hydrogen storage base material comprises magnesium or magnesium hydride.

14. The method as claimed in claim 7, wherein the transition metal comprises Ni or Al, and the transition metal had a size of 10-100 nm.

15. The method as claimed in claim 7, wherein the catalyst mixed with the hydrogen storage base material had a weight ratio of 3:7 to 1:9, and the transition metal is 2 to 10 percent by weight based on the weight of the hydrogen storage composite material.
